(19) United States
(12) Patent Application Publication
(10) Pub. No.: US 2006/0150962 A1
(43) Pub. Date: Jul. 13, 2006

(54) Air-fuel ratio feedback control apparatus for engines

(75) Inventors: Mamoru Uraki, Saitama (JP); Ryutaro Yamazaki, Saitama (JP); Tatsuo Hayashi, Saitama (JP); Tomoya Kono, Saitama (JP); Takeru Abe, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/315,256

(22) Filed: Dec. 23, 2005

(30) Foreign Application Priority Data
Dec. 24, 2004 (JP) 2004-373362

(51) Int. Cl. F02D 41/14

(52) U.S. Cl. 123/679; 123/683; 123/684

(57) ABSTRACT

An air-fuel ratio setting section sets a target air-fuel ratio KCMD according to the conditions of an engine. An air-fuel ratio correction coefficient calculating section calculates an air-fuel ratio correction coefficient KAF for controlling the air-fuel ratio wherein a detected air-fuel ratio KACT detected by a LAF sensor is converged to the target air-fuel ratio KCMD. A lower limit section constrains the air-fuel ratio correction coefficient KAF so as not to underrun the lower limit value. An upper limit section constrains the air-fuel ratio correction coefficient KAF so as not to exceed the upper limit value. A basic fuel injection time determining section calculates a basic fuel injection time TIM. A fuel injection time calculating section calculates a fuel injection time TOUT based on the target air-fuel ratio KCMD, the air-fuel ratio correction coefficient KAF, the basic fuel injection time TIM or the like, and various engine parameters.

### CROSS-REFERENCE TO RELATED APPLICATIONS

The present application claims priority under 35 USC 119 to Japanese Patent Application No. 2004-373362 filed on Dec. 24, 2004 the entire contents of which are hereby incorporated by reference.

### FIELD OF THE INVENTION

The present invention relates to an air-fuel ratio feedback control apparatus for an internal combustion engine and, more specifically, to an air-fuel ratio feedback control apparatus for an internal combustion engine suitable for preventing an over rich and an over lean mixture of the air-fuel ratio.

### BACKGROUND OF THE INVENTION

In an internal combustion engine, an air-fuel ratio feedback control is provided in which an air-fuel ratio correction coefficient is determined so as to converge an air-fuel ratio detected based on a concentration of oxygen in the exhaust gas to a target air-fuel ratio. A basic fuel injection time of a fuel injection valve is corrected by this air-fuel ratio correction coefficient. In the air-fuel ratio feedback control as such, the air-fuel ratio is controlled to a value adequately corresponding to the operating state of the engine, and learning control for improving the accuracy of the air-fuel ratio is simultaneously carried out.

However, in particular, when started from a cold state, an oil component or fuel which could not burn may attach to an air-fuel ratio sensor. In this case, it may be recognized as if the air-fuel ratio is in a rich state irrespective of the actual air-fuel ratio. Therefore, the present applicant previously proposed a control apparatus for preventing over lean by controlling a lower limit value of the air-fuel ratio correction coefficient according to the temperature at the time of engine start. See, JP-A-2003-83133.

In the control apparatus disclosed in JP-A-2003-83133, the lower limit value is provided to the air-fuel ratio correction coefficient according to the temperature at the time of engine start (that is, the temperature of cooling water). However, since the limit of the air-fuel ratio correction coefficient is not determined in the operating area other than the starting area, the air-fuel ratio may become unstable.

### SUMMARY AND OBJECTS OF THE INVENTION

It is an object of the invention to provide an air-fuel ratio feedback control apparatus for engines which can prevent over rich or over lean even in the operating area other than the starting area.

In order to achieve the above-described object, an air-fuel ratio feedback control apparatus for engines is provided for detecting an air-fuel ratio of an air-fuel mixture supplied to a combustion chamber and for controlling a fuel supply amount so that the detected air-fuel ratio is converged to a target air-fuel ratio, including an air-fuel ratio correcting means for correcting the target air-fuel ratio according to the operating state of the engine. The air-fuel ratio correcting means is configured to correct the target air-fuel ratio within a predetermined range between an upper limit value and a lower limit value.

According to an embodiment of the present invention, even when a sensor for detecting the air-fuel ratio outputs an abnormal value, the air-fuel ratio is controlled within the range between the upper limit value and the lower limit value, so that over lean and over rich are prevented.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing functions of principal portions of an air-fuel ratio feedback control apparatus according to an embodiment of the invention;

FIG. 2 is a system block diagram of an engine including the air-fuel ratio feedback control apparatus according to the embodiment of the invention; and

FIG. 3 is a flowchart for the processing of an air-fuel ratio correction coefficient.

### DETAILED DESCRIPTION OF THE PREFERRED EMBODIMENTS

Referring now to the drawings, an embodiment of the invention will be described. FIG. 2 is a system block diagram of an engine including an air-fuel ratio feedback control apparatus and the control apparatus according to the embodiment of the invention. In FIG. 2, for example, an air-intake pipe 2 is connected to a motorcycle engine 1 and is in communication with a combustion chamber thereof. A throttle valve 3 is disposed at a midsection of the air-intake pipe 2, and a throttle valve opening sensor 4 is connected to the throttle valve 3. Electric signals corresponding to an opening TH of the throttle valve detected by the throttle valve opening sensor 4 are supplied to an electronic control unit (ECU) 5.

Provided between the air-intake valve, not shown, on the air-intake pipe 2, and the throttle valve 3 is a fuel injection valve 6. In the case of a multi-cylinder engine, the fuel injection valves 6 are provided on the respective cylinders. Fuel in a fuel tank 7 is supplied to the fuel injection valve 6 by a fuel pump, not shown, and the fuel injection valve 6 injects fuel to the air-intake pipe 2 according to valve-opening instruction from the ECU 5. The amount of fuel injection is controlled by the valve-open time of the fuel injection valve 6. Fuel injected into the air-intake pipe 2 is mixed with air flowing through the throttle valve 3 into the air-intake pipe 2 into air-fuel mixture, which is supplied to the combustion chamber of the engine 1.

A negative pressure sensor 8 for detecting a pressure. PB of the air-intake pipe 2 and an intake-air temperature sensor 9 for detecting an intake-air temperature TA are mounted to the air-intake pipe 2. A water temperature sensor 10 for detecting a temperature of engine cooling water TW is provided on the main body of the engine 1. Detection signals from the respective sensors are supplied to the ECU 5.

Mounted on the periphery of a camshaft or a crankshaft (both are not shown) of the engine 1 are a revolution number sensor 11 for detecting a revolution number of the engine NE, and a cylinder discrimination sensor 12. The revolution number sensor 11 outputs TDC signal pulses for each top dead center TDC at the start of the intake stroke in each cylinder of the engine 1, and the cylinder discrimination sensor 12 outputs signal pulses at predetermined crank angle positions predetermined for each cylinder. These pulses are supplied to the ECU 5.

An exhaust pipe 13 connected to the engine 1 is provided with a three-way catalyst 14. The three-way catalyst 14 has a function to accumulate O2 in exhaust gas when exhaust air is in a lean state in which the air-fuel ratio of the air-fuel mixture supplied to the engine 1 is set to the lean side with respect to a theoretical air-fuel ratio (14.7) and the O2 concentration in the exhaust air is relatively high and on the other hand, to oxidize HC or CO in exhaust gas by accumulated O2 when the exhaust air is in a rich state in which the air-fuel ratio of the air-fuel mixture supplied to the engine 1 is set to the rich side with respect to the theoretical air-fuel ratio, and the O2 concentration in the exhaust gas is low, while HC or CO components are high.

A proportional oxygen concentration sensor (hereinafter, referred to as “LAF sensor”) 15 is added to the upstream of the three-way catalyst 14. The LAF sensor 15 outputs electric signals substantially proportional to the oxygen concentration in the exhaust air, which represents the air-fuel ratio, and supplies the same to the ECU 5.

The ECU 5 is composed of a computer, and includes a ROM for storing programs and data, a RAM for storing a required program and data and offering an operation working space at the time of execution of the program, a CPU for executing the program, an input interface for processing input signals from the respective sensors, and a drive circuit for sending control signals to the filel injection valve 6 and so on. The signal supplied from the respective sensors by the input interface is processed according to the program stored in the ROM.

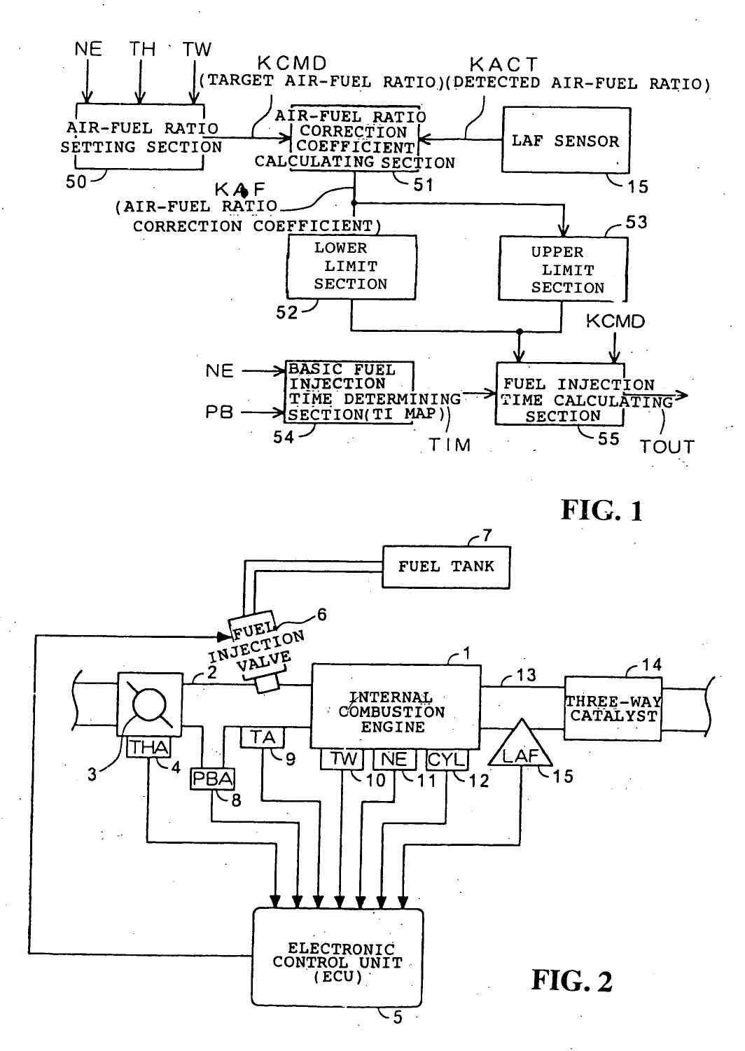

FIG. 1 is a block diagram showing functions of principal portions of the ECU 5. An air-fuel ratio setting section 50 sets various parameters according to the state of the engine, that is, it sets a target air-fuel ratio KCMD for optimizing drivability based on the number of revolutions of the engine NE, the throttle opening TH, the temperature of engine cooling water TW, and so on.

An air-fuel ratio correction coefficient calculating section 51 calculates an air-fuel ratio correction coefficient KAF for controlling the air-fuel ratio so that a detected air-fuel ratio KACT calculated from the output of the LAF sensor 15 is converged to the target air-fuel ratio KCMD when air-fuel ratio feedback control execution conditions are met.

A lower limit section 52 constrains the air-fuel ratio correction coefficient KAF calculated by the air-fuel ratio correction coefficient calculating section 51 so as not to underrun a predetermined lower limit value. An upper limit section 53 constrains the air-fuel ratio correction coefficient KAF calculated by the air-fuel ratio correction coefficient calculating section 51 so as not to exceed a predetermined upper limit value. The lower limit value and the upper limit value may be fixed values, or may be values varying according to the temperature of engine cooling water TW.

A basic fuel injection time determining section 54 calculates a basic fuel injection time TIM which represents a basic fuel amount. The basic fuel injection time TIM can be determined by searching a TI map set according to the number of revolutions of the engine NE and the internal pressure PB of the air-intake pipe. The TI map is set so that the air-fuel ratio of the air-fuel mixture supplied to the engine 1 becomes substantially the theoretical air-fuel ratio in the operating state corresponding to the number of revolutions of the engine NE and the internal pressure PB of the air-intake pipe. In other words, the amount of fuel injection represented by the basic fuel injection time TIM is substantially proportional to the amount of intake air of the engine per unit time.

A fuel injection time calculating section 55 calculates a fuel injection time TOUT based on the target air-fuel ratio KCMD, the air-fuel ratio correction coefficient KAF, the basic fuel injection time TIM, and detected various engine parameters with the following expression (1). TOUT=KTOTAL×KAF×KCMD×TIM (1), where KTOTAL is a coefficient representing a correction coefficient in total calculated from the temperature of engine cooling water TW, the intake-air temperature TA, and the ambient pressure and the like.

The ECU 5 controls so that the fuel injection valve 6 is opened for the fuel injection time TOUT synchronously with the TDC signal pulse.

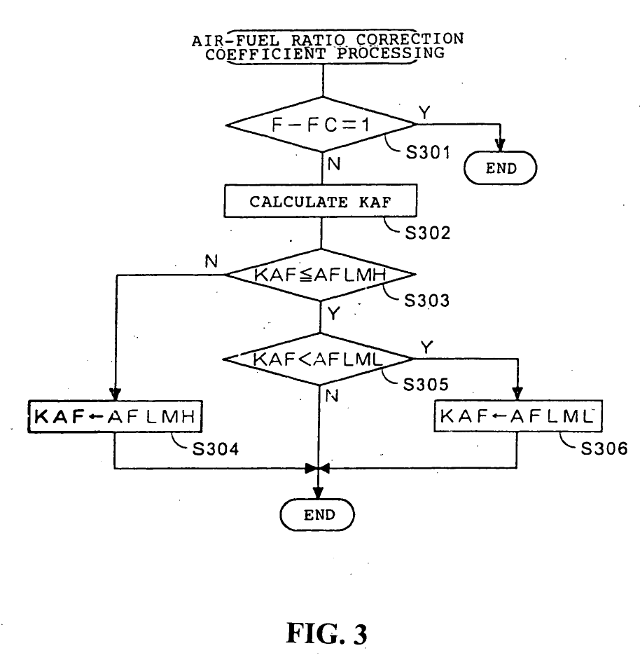

FIG. 3 is a flowchart of the processing of the air-fuel ratio correction coefficient of air-fuel ratio feedback control. In this processing, after having determined execution conditions of the feedback control, the air-fuel ratio correction coefficient KAF is calculated based on the output of the LAF sensor 15 or the like, and the feedback control is executed.

In Step S301, a flag F-FC which indicates the fuel-cut condition is determined. When the flag F-FC=0, that is, when it is not in the fuel-cut condition, the air-fuel ratio correction coefficient KAF is calculated by a predetermined expression so that the detected air-fuel ratio KACT becomes an optimal air-fuel ratio according to the engine conditions determined by various parameters in Step S302.

In Step S303, whether or not the air-fuel ratio correction coefficient KAF does not exceed a fuel correction upper limit value AFLMH is determined. When the air-fuel ratio correction coefficient KAF is larger than the fuel correction upper limit value AFLMH, the procedure goes to Step S304, where the air-fuel ratio correction coefficient KAF is replaced by the fuel correction upper limit value AFLMH.

On the other hand, if the result of determination is affirmative in Step S303, that is, when the air-fuel ratio correction coefficient KAF is equal to or smaller than the fuel correction upper limit value AFLMH, the procedure goes to Step S305. In Step S305, whether or not the air-fuel ratio correction coefficient KAF is smaller than a fuel correction lower limit value AFLML is determined. When the air-fuel ratio correction coefficient KAF is smaller than the fuel correction lower limit value AFLML, the procedure goes to the Step S306, where the air-fuel ratio correction coefficient KAF is replaced by the fuel correction lower limit value AFLML. When the air-fuel ratio correction coefficient KAF is equal to or larger than the fuel correction lower limit value AFLML, the determination in Step S305 is negative, and the value calculated in Step S302 is employed as the air-fuel ratio correction coefficient KAF, and is supplied to the fuel injection time calculating section 55.

As described above, in this embodiment, when the calculated air-fuel ratio correction coefficient KAF is larger than the predetermined upper limit value or smaller than the lower limit value, the calculated air-fuel ratio correction coefficient KAF is limited by the upper limit value and the lower limit value, respectively.

Instead of setting the upper limit value AFLMH and the lower limit value AFLML with respect to the air-fuel ratio correction coefficient KAF, it is also possible to set the upper limit value and the lower limit value of the target air-fuel ratio KCMD set by the air-fuel ratio setting section 50 across. (that is, over and below) the theoretical air-fuel ratio “14.7”, respectively. The upper limit value and the lower limit value are preferably set in the range of ±20% of the theoretical air-fuel ratio. For example, the upper limit value is set to approx. 12.1, and the lower limit value is set to approx. 18.1.

By employing the above described upper limit value and the lower limit value of the air-fuel ratio -correction coefficient KAF or the target air-fuel ratio KCMD, for both over rich and over lean can be prevented. The upper limit value and the lower limit value of the air-fuel ratio correction coefficient KAF or the target air-fuel ratio KCMD may be fixed values, or may be the function of the temperature of engine cooling water TW or the time from engine start. For example, the variable which has a tendency such that the fuel correction lower limit value AFLML decreases with increase in temperature of engine cooling water TW or increase in elapsed time from starting of engine.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An air-fuel ratio feedback control apparatus for engines which detects an air-fuel ratio of an air-fuel mixture supplied to a combustion chamber and controls a fuel supply amount so that the detected air-fuel ratio is converged to a target air-fuel ratio comprising:
an air-fuel ratio correcting means for correcting the target air-fuel ratio according to the operating state of the engine,
wherein the air-fuel ratio correcting means is configured to correct the target air-fuel ratio within a predetermined range between an upper limit value and a lower limit value.

2. The air-fuel ratio feedback control apparatus according to claim 1, wherein the upper limit value and the lower limit value of the target air-fuel ratio is provided above and below a theoretical air-fuel ratio respectively.

3. The air-fuel ratio feedback control apparatus according to claim 1, wherein the upper limit value and the lower limit value of the target air-fuel ratio is provided within plus or minus 20% of a theoretical air-fuel ratio.

4. The air-fuel ratio feedback control apparatus according to claim 3, wherein the theoretical air-fuel ratio is 14.7 with the upper limit being approximately 12.1 and the lower limit being approximately 18.1.

5. The air-fuel ratio feedback control apparatus according to claim 1, wherein the air-fuel ratio correcting means includes an air-fuel ratio correction coefficient calculating section for calculating an air-fuel ratio correction coefficient KAF for controlling the air-fuel ratio.

6. The air-fuel ratio feedback control apparatus according to claim 5, and further including an air-fuel ratio setting section for setting a target air-fuel ratio KCMD according to conditions of the engine.

7. The air-fuel ratio feedback control apparatus according to claim 6, wherein the air-fuel ratio setting section receives a number of revolutions of the engine NE, an electrical signal corresponding to an opening TH of a throttle and a temperature of the cooling water TW of the engine for setting the target air-fuel, ratio KCMD.

8. The air-fuel ratio feedback control apparatus according to claim 5, and further including a proportional oxygen concentration sensor operatively positioned upstream of a catalyst for outputting electrical signals substantially proportional to the oxygen concentration in the exhaust air and for supplying the electrical signals to the air-fuel ratio correction coefficient calculating section.

9. The air-fuel ratio feedback control apparatus according to claim 5, and further including a fuel injection time calculating section for receiving an air-fuel ratio as filtered by a lower limit section and an upper limit section and for receiving a basic fuel injection time determining output for generating a fuel injection time.

10. The air-fuel ratio feedback control apparatus according to claim 9, wherein the basic fuel injection time determining output receives a number of revolutions of the engine NE and an internal pressure PB of an air-intake pipe for generating a basic fuel injection time TIM that is substantially proportional to an amount of intake air of the engine per unit time.

11. An air-fuel ratio feedback control apparatus adapted to be used for engines comprising:
an air-fuel ratio detector for detecting an air-fuel mixture supplied to a combustion chamber and for controlling a fuel supply amount so that the detected air-fuel ratio is converged to a target air-fuel ratio;
an air-fuel ratio correcting means for correcting the target air-fuel ratio according to the operating state of the engine; and
said air-fuel ratio correcting means being configured to correct the target air-fuel ratio within a predetermined range between an upper limit value and a lower limit value.

12. The air-fuel ratio feedback control apparatus according to claim 11, wherein the upper limit value and the lower limit value of the target air-fuel ratio is provided above and below a theoretical air-fuel ratio respectively.

13. The air-fuel ratio feedback control apparatus according to claim 11, wherein the upper limit value and the lower limit value of the target air-fuel ratio is provided within plus or minus 20% of a theoretical air-fuel ratio.

14. The air-fuel ratio feedback control apparatus according to claim 13, wherein the theoretical air-fuel ratio is 14.7 with the upper limit being approximately 12.1 and the lower limit being approximately 18.1.

15. The air-fuel ratio feedback control apparatus according to claim 11, wherein the air-fuel ratio correcting means includes an air-fuel ratio correction coefficient calculating section for calculating an air-fuel ratio correction coefficient KAF for controlling the air-fuel ratio.

16. The air-fuel ratio feedback control apparatus according to claim 15, and further including an air-fuel ratio setting section for setting a target air-fuel ratio KCMD according to conditions of the engine.

17. The air-fuel ratio feedback control apparatus according to claim 16, wherein the air-fuel ratio setting section receives a number of revolutions of the engine NE, an electrical signal corresponding to an opening TH of a throttle and a temperature of the cooling water TW of the engine for setting the target air-fuel ratio KCMD.

18. The air-fuel ratio feedback control apparatus according to claim 15, and further including a proportional oxygen concentration sensor operatively positioned upstream of a catalyst for outputting electrical signals substantially proportional to the oxygen concentration in the exhaust air and for supplying the electrical signals to the air-fuel ratio correction coefficient calculating section.

19. The air-fuel ratio feedback control apparatus according to claim 15, and further including a fuel injection time calculating section for receiving an air-fuel ratio as filtered by a lower limit section and an upper limit section and for receiving a basic fuel injection time determining output for generating a fuel injection time.

20. The air-fuel ratio feedback control apparatus according to claim 19, wherein the basic fuel injection time determining output receives a number of revolutions of the engine NE and an internal pressure PB of an air-intake pipe for generating a basic fuel injection time TIM that is substantially proportional to an amount of intake air of the engine per unit time.
